(19) United States
(12) Patent Application Publication
(10) Pub. No.: US 2025/0253689 A1
(43) Pub. Date: Aug. 7, 2025

(54) Phone Charging Case Device

(71) Applicant: Jacqueline Harris, Woodbridge, VA (US)

(72) Inventor: Jacqueline Harris, Woodbridge, VA (US)

(21) Appl. No.: 18/810,655

(22) Filed: Aug. 21, 2024

Related U.S. Application Data
(60) Provisional application No. 63/549,702, filed on Feb. 5, 2024.

(51) Int. Cl. H02J 7/00; A45C 11/00; A45C 13/00; H01M 50/247; H04R 1/02

(52) U.S. Cl. CPC H02J 7/0044; A45C 11/00; A45C 13/002; H01M 50/247; H02J 7/0013; H02J 7/0048; H02J 7/0068; H04R 1/028; A45C 11/002; H01M 2220/30; H02J 2207/30; H04R 2420/07

(57) ABSTRACT

A phone charging case device is provided. The device is comprised of a phone case device comprised of a body with a receiving area for securely attaching a phone via a male charging port and that is powered by an internal battery rechargeable through a wall outlet plug via a second male charging port on the body of the device. The device can function as a portable charger, allowing users to control the power distribution between the phone and battery via a button, with status indicators provided by lights. Additionally, the case integrates a speaker, volume controls, and Bluetooth connectivity, enabling it to function as a Bluetooth speaker.

### CROSS-REFERENCE TO RELATED APPLICATION

The present application claims priority to, and the benefit of, U.S. Provisional Application No. 63/549,702, which was filed on Feb. 5, 2024, and is incorporated herein by reference in its entirety.

### FIELD OF THE INVENTION

The present invention relates generally to the field of cell phone cases. More specifically, the present invention relates to a phone charging case device that can provide portable charging to a cell phone inside the device, wherein a battery of the device can be charged via a wall outlet using an integrated male wall outlet plug of the device body. Accordingly, the present disclosure makes specific reference thereto. Nonetheless, it is to be appreciated that aspects of the present invention are also equally applicable to other like applications, devices, and methods of manufacture.

### BACKGROUND

Finding electrical outlets and power cables to charge a cell phone can be frustrating, especially when away from home. This issue is compounded by the necessity of carrying a power cable with you at all times, which can be undesirable due to the inconvenience and the risk of the cable being damaged or lost. People who are away from home and lack access to a charger may find themselves unable to charge their phone, leading to the potential of missing important phone calls, texts, and emails. This situation can be particularly stressful in professional settings or emergency situations where timely communication is crucial.

In addition, many people rely on their cell phones for a variety of other essential functions beyond communication. For instance, phones are often used for navigation, making it even more critical to maintain a charged battery when traveling or exploring unfamiliar areas. The reliance on mobile devices for accessing information, managing schedules, and staying connected with others means that an uncharged phone can disrupt many aspects of daily life.

Moreover, in social settings, having a charged phone is often necessary to capture photos, share moments on social media, or stay connected with friends and family. The inconvenience of a dead phone battery can lead to missed opportunities and diminished experiences. In addition to the inconvenience of charging, individuals may also wish to use their phones for audio playback. For example, they may want to play music at a volume louder than what their phone can naturally output. While portable Bluetooth speakers can address this need, it isn't always practical or desirable to carry an additional device for this purpose.

Portable Bluetooth speakers, while providing enhanced audio quality and volume, can be bulky and require additional charging themselves. This means users must manage multiple devices and their respective power needs, which can be cumbersome. Furthermore, the added weight and space taken up by a Bluetooth speaker can be a deterrent for those who prefer to travel light or carry minimal items.

Therefore, there exists a long-felt need in the art for an improved cell phone charging device. There also exists a long-felt need in the art for a phone charging case device. Further, there exists a long-felt need in the art for a phone charging case device that can be used to charge a cell phone without the need for a power outlet. In addition, there exists a long-felt need in the art for a phone charging case device that can be used to charge a cell phone without the need for a charging cord. In addition, there exists a long-felt need in the art for a phone charging case device that can be used as a Bluetooth speaker.

The subject matter disclosed and claimed herein, in one embodiment thereof, comprises a phone charging case device. The device is comprised of a phone case device comprised of a body with a receiving area for securely attaching a phone via a male charging port and that is powered by an internal battery rechargeable through a wall outlet plug via a second male charging port on the body of the device. The device can function as a portable charger, allowing users to control the power distribution between the phone and battery via a button, with status indicators provided by lights. Additionally, the case integrates a speaker, volume controls, and Bluetooth connectivity, enabling it to function as a Bluetooth speaker.

In this manner, the phone charging case device of the present invention accomplishes all the forgoing objectives and provides an improved cell phone charging device. The device protects a phone as a case but also can be used to charge a cell phone without the need for a power outlet or a charging cord. In addition, the device can be used as a Bluetooth speaker.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a phone charging case device comprised of a phone case body that preferably has at least three sides that form at least one receiving area that receives a phone via sliding the phone into the body and/or placing/snapping the body around the phone. The receiving area is comprised of at least one male charging port that engages a female charging port of a phone. The charging port receives power from at least one battery. The battery can be charged via at least one charging port. The port is preferably a male 120v wall outlet plug but may be any male or female plug type.

In one embodiment, the device can be used as a portable charger for a phone when the user is not near a power outlet. The device can also be used in lieu of a phone charging cord, wherein the charging port can be plugged directly into a female wall outlet wherein the phone is attached to the male charging port within the body. As a result, the battery receives power from the outlet, which then supplies power to the phone. A user can alternatively plug the device into an outlet without a phone inside the body in order to simply charge the battery of the device. The device may be comprised of at least one button that allows a user to control whether the battery supplies power to a phone via the male charging port. As a result, a phone can remain inside the body and attached to the male charging port, wherein the charging port can further be plugged into a wall outlet. Then, a user can use the button to select whether only the battery is charged, whether the battery is charged while also charging the phone via the male charging port, or whether only the phone is charged.

The body may also be comprised of at least one speaker, wherein a volume of the speaker can be controlled via at least one volume control in the form of a button or other structure. The speaker may be in wired communication with the phone via the charging port or may wirelessly connect to an external smart device via a Bluetooth transmitter. As a result, the device can be used as a Bluetooth speaker. In one embodiment, the body may receive two phones.

The present invention is also comprised of a method of using the device. First, a device is provided comprised of a body comprised of a receiving area comprised of a first male charging port, a battery, and a second male charging port. Then, a phone can be placed into the receiving area such that the first male charging port engages a female charging port of the phone. Then, the second male charging port can be placed into a female wall outlet receptacle such that power is supplied to the battery. Finally, a user can use a button to select whether power is supplied only to the battery, to the battery and to the phone (via the male charging port), or only to the phone (via the male charging port).

Accordingly, the phone charging case device of the present invention is particularly advantageous as it provides an improved cell phone charging device. The device protects a phone as a case but also can be used to charge a cell phone without the need for a power outlet or a charging cord. In addition, the device can be used as a Bluetooth speaker. In this manner, the phone charging case device provides numerous solutions to various cell phone-related charging and usage problems.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a phone charging case device of the present invention in accordance with the disclosed architecture;

FIG. 2 illustrates a rear perspective view of one potential embodiment of a phone charging case device of the present invention in accordance with the disclosed architecture;

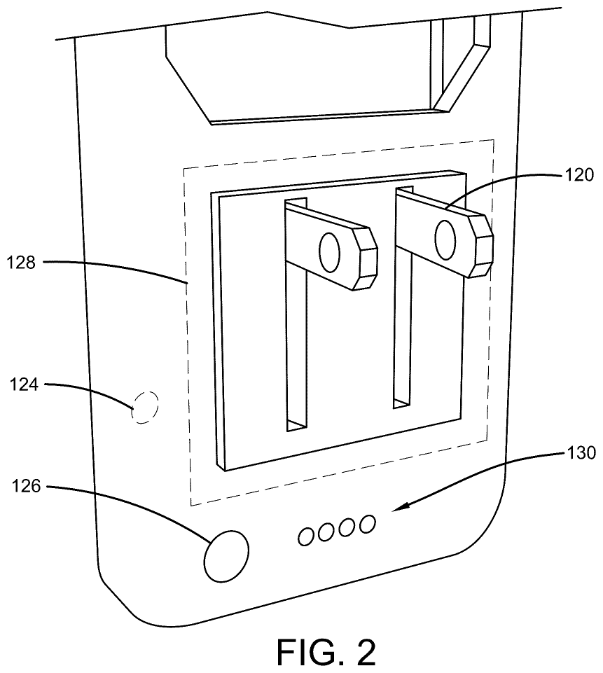

FIG. 3 illustrates a front perspective view of one potential embodiment of a phone charging case device of the present invention with a phone inside the body of the device in accordance with the disclosed architecture;

FIG. 4 illustrates a flowchart of a method of using one potential embodiment of a phone charging case device of the present invention in accordance with the disclosed architecture; and

FIG. 5 illustrates a flowchart of a method of using one potential embodiment of a phone charging case device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved cell phone charging device. There also exists a long-felt need in the art for a phone charging case device. Further, there exists a long-felt need in the art for a phone charging case device that can be used to charge a cell phone without the need for a power outlet. In addition, there exists a long-felt need in the art for a phone charging case device that can be used to charge a cell phone without the need for a charging cord. In addition, there exists a long-felt need in the art for a phone charging case device that can be used as a Bluetooth speaker.

The present invention, in one exemplary embodiment, is comprised of a phone charging case device. The device is comprised of a phone case body. The body preferably has at least three sides that form at least one receiving area that receives a phone via sliding the phone into the body and/or placing/snapping the body around the phone. The receiving area is comprised of at least one male charging port that engages a female charging port of a phone. The charging port receives power from at least one battery. The battery can be charged via at least one charging port. The port is preferably a male 120v wall outlet plug but may be any male or female plug type.

In one embodiment, the device can be used as a portable charger for a phone when the user is not near a power outlet. The device can also be used in lieu of a phone charging cord, wherein the charging port can be plugged directly into a female wall outlet wherein the phone is attached to the male charging port within the body. As a result, the battery receives power from the outlet, which then supplies power to the phone. A user can alternatively plug the device into an outlet without a phone inside the body in order to simply charge the battery of the device. The device may be comprised of at least one button that allows a user to control whether the battery supplies power to a phone via the male charging port. As a result, a phone can remain inside the body and attached to the male charging port, wherein the charging port can further be plugged into a wall outlet. Then, a user can use the button to select whether only the battery is charged, whether the battery is charged while also charging the phone via the male charging port, or whether only the phone is charged.

The body may also be comprised of at least one speaker, wherein a volume of the speaker can be controlled via at least one volume control in the form of a button or other structure. The speaker may be in wired communication with the phone via the charging port or may wirelessly connect to an external smart device via a Bluetooth transmitter. As a result, the device can be used as a Bluetooth speaker. In one embodiment, the body may receive two phones.

The present invention is also comprised of a method of using the device. First, a device is provided comprised of a body comprised of a receiving area comprised of a first male charging port, a battery, and a second male charging port. Then, a phone can be placed into the receiving area such that the first male charging port engages a female charging port of the phone. Then, the second male charging port can be placed into a female wall outlet receptacle such that power is supplied to the battery. Finally, a user can use a button to select whether power is supplied only to the battery, to the battery and to the phone (via the male charging port), or only to the phone (via the male charging port).

Accordingly, the phone charging case device of the present invention is particularly advantageous as it provides an improved cell phone charging device. The device protects a phone as a case but also can be used to charge a cell phone without the need for a power outlet or a charging cord. In addition, the device can be used as a Bluetooth speaker. In this manner, the phone charging case device provides numerous solutions to various cell phone-related charging and usage problems.

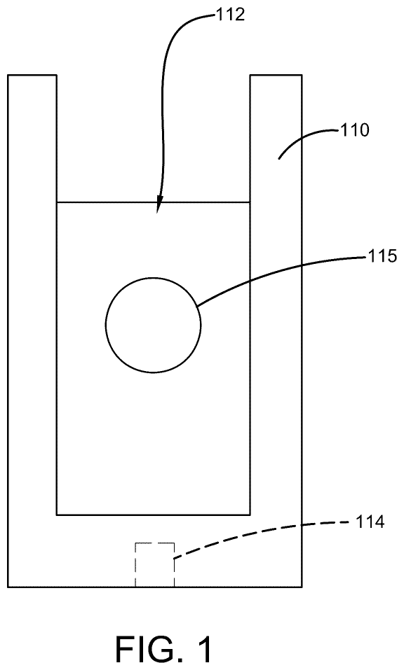

Referring initially to the drawings, FIG. 1 illustrates a front perspective view of one potential embodiment of a phone charging case device 100 of the present invention in accordance with the disclosed architecture. The device 100 is comprised of a phone case body 110. The body 110 may be any size and shape to accommodate any style of phone known in the art. The body 110 may be any color and may be made from any material such as but not limited to a silicone, a rubber, a plastic, a leather, a carbon fiber, a metal, etc. The body 110 may be comprised of a removable and replaceable screen protector 111 that may be made of a transparent or tinted (i.e., privacy screen) material. The body 110 may further be comprised of a raised and/or recessed texture 116 to improve grip. The body 110 preferably has at least three sides 113 that protect at least three sides of a phone 10. The body 110 may also be comprised of openings 134 that allow for a user to access/control buttons of the phone 10 through the body 110.

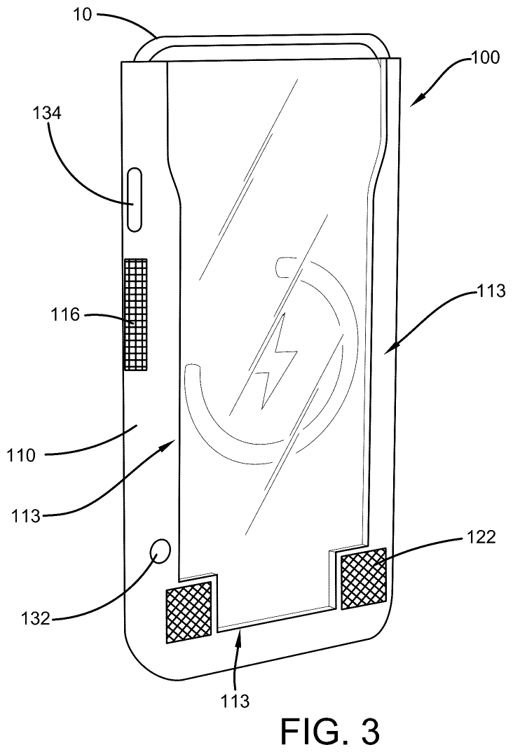

The body 110 is comprised of at least one receiving area 112 (formed by the sides 113) that receives a phone 10 via sliding the phone 10 into the body 110 and/or placing/snapping the body 110 around the phone 10. The receiving area 112 is comprised of at least one male charging port 114 (as seen in FIG. 1) that engages a female charging port of a phone 10. The port 114 may be any style such as but not limited to USB C, lightning, etc. In a further embodiment, the receiving area 112 may be additionally or alternatively comprised of at least one wireless charging structure 115 of any type/style. The charging port 114 and charging structure 115 receive power from at least one battery 128. The battery 128 can be charged via at least one charging port 120. The port 120 is preferably a male 120v wall outlet plug (as seen in FIG. 3) but may be any male or female plug type.

In one embodiment, the device 100 can be used as a portable charger for a phone 10 when the user is not near a power outlet. The device 100 can also be used in lieu of a phone charging cord, wherein the charging port 120 can be plugged directly into a female wall outlet wherein the phone 10 is attached to the male charging port 114 within the body 110. As a result, the battery 128 receives power from the outlet, which then supplies power to the phone 10. A user can alternatively plug the device 100 into an outlet without a phone 10 inside the body 110 in order to simply charge the battery 128 of the device 100. The device 100 may be comprised of at least one button 126 that allows a user to control whether the battery 128 supplies power to a phone 10 via the male charging port 114. As a result, a phone 10 can remain inside the body 110 and attached to the male charging port 114, wherein the charging port 120 can further be plugged into a wall outlet. Then, a user can use the button 126 to select whether only the battery 128 is charged, whether the battery 128 is charged while also charging the phone 10 via the male charging port 114, or whether only the phone 10 is charged. A power level of the battery 128 can also be displayed via at least one indicator light 130 of any color and configuration.

The body 110 may also be comprised of at least one speaker 122 (as seen in FIG. 3), wherein a volume of the speaker 122 can be controlled via at least one volume control 132 in the form of a button or other structure. The speaker 122 may be in wired communication with the phone 10 via the charging port 114 or may wirelessly connect to an external smart device via a Bluetooth transmitter 124. As a result, the device 100 can be used as a Bluetooth speaker. In one embodiment, the body 110 may receive two phones 10.

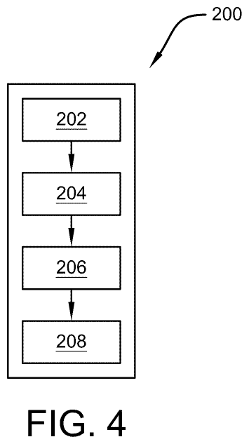

The present invention is also comprised of a method of using 200 the device 100, as seen in FIG. 4. First, a device 100 is provided comprised of a body 110 comprised of a receiving area 112 comprised of a first male charging port 114, a battery 128, and a second male charging port 120 [Step 202]. Then, a phone 10 can be placed into the receiving area 112 such that the first male charging port 114 engages a female charging port of the phone 10 [Step 204]. Then, the second male charging port 120 can be placed into a female wall outlet receptacle such that power is supplied to the battery 128 [Step 206]. Finally, a user can use a button 126 to select whether power is supplied only to the battery 128, to the battery 128 and to the phone 10 (via the male charging port 114), or only to the phone 10 (via the male charging port 114) [Step 208].

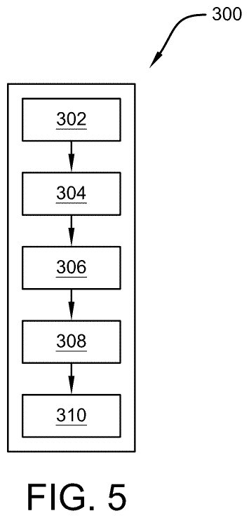

The present invention is also comprised of a method of using 300 the device 100, as seen in FIG. 5. First, a device 100 is provided comprised of a body 110 comprised of a receiving area 112 comprised of a first male charging port 114, a battery 128, and a second male charging port 120, a speaker 122, and a transmitter 124 [Step 302]. Then, a phone 10 can be placed into the receiving area 112 such that the first male charging port 114 engages a female charging port of the phone 10 [Step 304]. Then, the second male charging port 120 can be placed into a female wall outlet receptacle such that power is supplied to the battery 128 [Step 306]. Next, a user can use a button 126 to select whether power is supplied only to the battery 128, to the battery 128 and to the phone 10 (via the male charging port 114), or only to the phone 10 (via the male charging port 114) [Step 308]. A user can then wirelessly connect a transmitter 124 of the device 100 to a Bluetooth smart device to allow music to be played from the smart device out of the speaker 122 of the device 100, or to be played via a wired connection via the phone 10 attached to the male charging port 114 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “phone charging case device” and “device” are interchangeable and refer to the phone charging case device 100 of the present invention.

Notwithstanding the forgoing, the phone charging case device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the phone charging case device 100 as shown in the FIGS. are for illustrative purposes only, and that many other sizes and shapes of the phone charging case device 100 are well within the scope of the present disclosure. Although the dimensions of the phone charging case device 100 are important design parameters for user convenience, the phone charging case device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A phone charging case device comprising:
a body comprised of:
a receiving area comprised of a first male charging port;
a second male charging port;
a battery;
a button;
a transmitter; and
a speaker.

2. The phone charging case device of claim 1, wherein the first male charging port is comprised of a USB C port or a lightning port.

3. The phone charging case device of claim 1, wherein the second male charging port is comprised of a male 120v power outlet plug.

4. The phone charging case device of claim 1, wherein the battery receives power from the second male charging port.

5. The phone charging case device of claim 1, wherein the first male charging port receives power from the battery.

6. The phone charging case device of claim 1, wherein the body is comprised of an indicator light that displays a power level of the battery.

7. The phone charging case device of claim 1, wherein the transmitter is comprised of a wireless Bluetooth transmitter.

8. A phone charging case device comprising:
a body comprised of:
a receiving area comprised of a first male charging port, the receiving area formed by a first side, a second side, and a third side of the body;
a second male charging port;
a battery;
a button;
a transmitter; and
a speaker.

9. The phone charging case device of claim 8, wherein the body is comprised of a raised textured or a recessed texture.

10. The phone charging case device of claim 8, wherein the body is comprised of a removable screen protector.

11. The phone charging case device of claim 10, wherein the removable screen protector is comprised of a privacy screen.

12. The phone charging case device of claim 8, wherein the body is comprised of an opening.

13. The phone charging case device of claim 8, wherein the first male charging port is comprised of a wireless charging port.

14. The phone charging case device of claim 8, wherein the second male charging port is comprised of a male 120v power outlet plug.

15. The phone charging case device of claim 8, wherein the battery receives power from the second male charging port.

16. The phone charging case device of claim 8, wherein the first male charging port receives power from the battery.

17. The phone charging case device of claim 8, wherein the body is comprised of an indicator light that displays a power level of the battery.

18. The phone charging case device of claim 8, wherein the transmitter is comprised of a wireless Bluetooth transmitter.

19. A method of using a phone charging case device, the method comprising the following steps:
providing a phone charging case device comprised of a receiving area comprised of a first male charging port, a battery, and a second male charging port;
placing a phone into the receiving area such that the first male charging port engages the phone;
placing the second male charging port into a wall outlet receptacle; and
using a button of the phone charging case device to select whether power is supplied only to the battery, to the battery and to the phone via the male charging port, or only to the phone via the male charging port.

20. The method of using a phone charging case device of claim 19, wherein the second male charging port is comprised of a male 120v power outlet plug.
